(19) United States
(12) Patent Application Publication
(10) Pub. No.: US 2024/0376761 A1
(43) Pub. Date: Nov. 14, 2024

(54) GROUND OPERATED ROOF-BASED ACCESS HATCH FOR A FRACKING SANDBOX

(71) Applicant: Elisardo Aranda, Midland, TX (US)

(72) Inventor: Elisardo Aranda, Midland, TX (US)

(21) Appl. No.: 18/655,826

(22) Filed: May 6, 2024

Related U.S. Application Data
(60) Provisional application No. 63/464,784, filed on May 8, 2023.

(51) Int. Cl. E05F 11/06; E21B 43/26

(52) U.S. Cl. CPC E05F 11/06; E21B 43/2607; E05Y 2201/668; E05Y 2201/71

(57) ABSTRACT

A ground operated roof-based access hatch for a sandbox associated with fracking includes a door panel positioned atop the sandbox and movable between an open configuration allowing access to an interior of sandbox and a closed configuration preventing access thereto. The access hatch includes a linkage having an access control portion operatively coupled to the door panel and configured for moving the door panel between open and closed configurations when actuated and an operator control portion positioned at a bottom of the sandbox that is configured to transmit movement data from an operator to the access control portion, whereby the operator is able to control movements of the door panel from a ground surface. The linkage may include a sprocket and gear assembly having an elongate rope or chain that is both operable a bottom at of the sandbox and operable to open or close the access lid.

### REFERENCE TO RELATED APPLICATIONS

This is a non-provisional patent application claiming the priority of provisional application 63/464,784 filed May 8, 2023 titled Ground Operated Roof-Based Access Hatch for a Fracking Sandbox which is incorporated herein by reference in its entirety.

### BACKGROUND OF THE INVENTION

This invention relates generally to access doors and, more particularly to a roof-based access hatch for a fracking sandbox.

Fracking sandboxes play a crucial role in the oil and gas industry by providing a controlled environment for managing sand used during hydraulic fracturing operations. Traditionally, sand is mixed with the fracking fluid and is pumped into the well to prop open the fractures that are created. The so-called “sandbox” is a container-like structure placed at the surface or in close proximity to a fracking wellhead and which provides numerous advantages and improvements to the overall efficiency and effectiveness of the fracking operation. Namely, the sandbox has become a critical element of the fracking process as it facilitates efficient control and management of the sand used in the fracking process. By pre-storing the sand in the sandbox, it ensures a constant supply of sand and minimizes delays or disruptions during fracking operations. Further, having a ready supply of sand permanently located at the well site, transportation and logistics become more streamlined. There is no longer a need to transport sand to the site during the fracking operation and this results in significant cost savings and reduced environmental impact. Finally, the sandbox design can be scaled up and or down depending on the size and requirements of the fracking operation.

Access into a sandbox is essential for inspection, maintenance, and replenishment of sand during hydraulic fracturing operations. More particularly, the access hatch is traditionally strategically located on the roof of the sandbox structure so as to provide a secure and accessible entry point for personnel to inspect and maintain the sandbox as well as to add or remove sand as required by fracking operations. Traditionally, a user of the sandbox was required to position and scale a ladder to reach a top surface of the sandbox and, thus, to access the hatch door. As a typical sandbox extends upwardly to a height similar to that of a semitruck trailer, the dangers of a fallen ladder or falling from the top surface are apparent. In an attempted solution to the danger of accessing an access hatch via a ladder, and access door may be equipped with a radio signal remote control. Unfortunately, equipping hundreds or even thousands of fracking sandboxes with electronics is expensive to retrofit or to repair.

Therefore, it would be desirable to have a roof-based access hatch that is mechanically operable from the ground so as to eliminate a need for a worker to position and scale a ladder in order to access the access hatch. Further, it would be desirable to have a roof-based access hatch that is operable from a ground surface that includes operational components that are intuitive and user-friendly, facilitates smooth operations, and reduces the risk of error. In addition, the ground-operated access hatch is constructed of durable mechanical materials that are better able to withstand the harsh conditions encountered in oil and gas fracking operations than are electronic or remote-control mechanisms.

### SUMMARY OF THE INVENTION

This invention is directed to a ground operated roof-based access hatch for a fracking sandbox according to the present invention includes a door panel positioned atop the sandbox and movable between an open configuration allowing access to an interior of the sandbox and a closed configuration preventing access thereto. The access hatch includes a linkage having an access control portion operatively coupled to the door panel and configured for moving the door panel between open and closed configurations when actuated and an operator control portion positioned at a bottom of the sandbox that is configured to transmit movement data from an operator to the access control portion, whereby the operator is able to control movements of the door panel from a ground surface. The linkage may include a sprocket and gear assembly having an elongate rope or chain that is both operable at a bottom of the sandbox and at a top of the sandbox to open or close the access lid.

Therefore, a general object of this invention is to provide a roof-based access hatch for a fracking sandbox that is operable using a ground-level mechanical linkage.

Another object of this invention is to provide a roof-based access hatch for a fracking sandbox, as aforesaid, that may be selectively opened or closed without a technician having to position and scale a ladder, where use of a ladder to scale a fracking sandbox is inherently dangerous.

Still another object of this invention is to provide a roof-based access hatch for a fracking sandbox, as aforesaid, that is operable from a base of the sandbox using a pulley and sprocket configuration.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a roof-based access hatch operable from a base of a fracking sandbox according to a preferred embodiment of the present invention, illustrated with the door panel in a closed configuration;

FIG. 2 is another perspective view of the access hatch as in FIG. 1, illustrated with the door panel in an open configuration;

FIG. 3a is a side view of the access hatch as in FIG. 1;

FIG. 3b is a perspective view from a lower angle of the access hatch as in FIG. 1;

FIG. 3c is an isolated view on an enlarged-scale taken from FIG. 3b;

FIG. 4a is another side view of the access hatch as in FIG. 1;

FIG. 4b is a sectional view taken along line 4b-4b of FIG. 4a;

FIG. 5a is a perspective view of a linkage in communication with a door panel of the access hatch removed from the sandbox according to the present invention;

FIG. 5b is an isolated view on an enlarged scale taken from FIG. 5a;

FIG. 5c is an isolated view on an enlarged scale taken from FIG. 5a;

FIG. 6a is a perspective view of a hinge shaft and gear train according to the present invention; and

FIG. 6b is an isolated view on an enlarged scale taken from FIG. 6a.

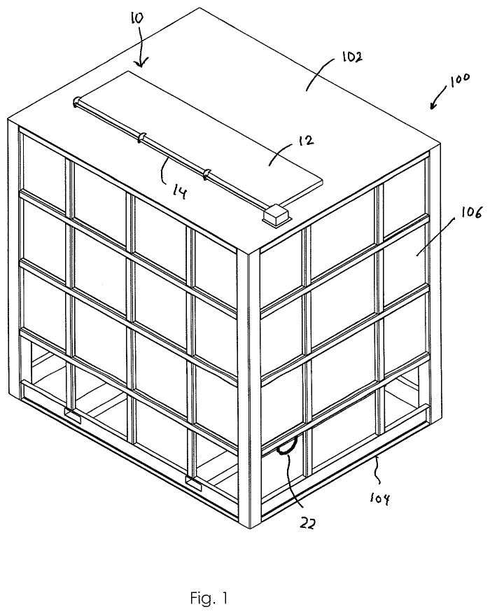

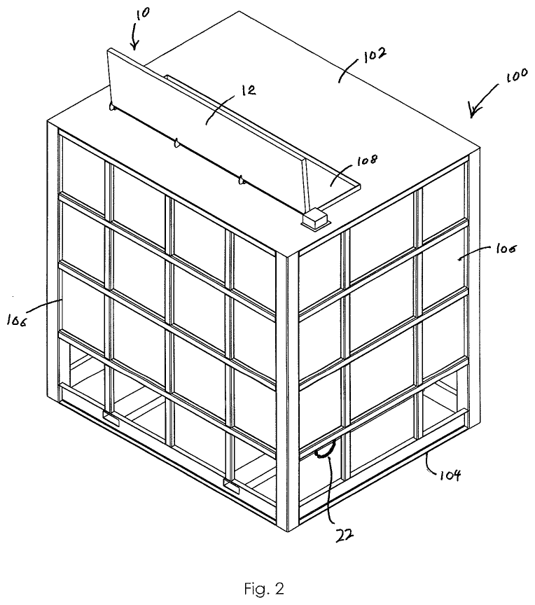

### DESCRIPTION OF THE PREFERRED EMBODIMENT

A ground operated roof-based access hatch according to a preferred embodiment of the present invention will now be described with reference to the accompanying drawings. The ground operated roof-based access hatch includes a door panel and a mechanical linkage that is operable to open or close the door panel from a ground surface.

A sandbox used in the process of hydraulic fracking is a large container having an appearance similar to a large cube or sometimes like a semitruck trailer and may, in fact, have wheels and be pulled behind the cab of a semitruck. Once on site, the sandbox 100 may be properly positioned using a crane proximate a wellbore site and may be filled with sand that will be used systematically in a fracking operation. For context, the sandbox may include a roof 102 (which may also be referred to as a top or upper wall) and a bottom 104 (which may also be referred to as a base or lower wall) with multiple side walls 106 extending upwardly between the bottom and top walls, respectively. In other words, the sandbox 100 may have a generally rectangular configuration that mimics the size of a semitruck trailer. Traditionally, the roof 102 of a sandbox 100 defines an aperture 108 (which may also be referred to as a port or opening) by which sand may be added or removed from an interior area defined by the walls thereof. The opening to the interior area may be selectively covered by a sealed door panel 12 (such as sealed with an O-ring or rubber gasket) so as to protect the sand therein from moisture and to protect a worker from inadvertently falling into the interior area. In any case, the sandbox 100 has a substantial height and, therefore, presents a risk when a worker ascends up a ladder to the roof of the sandbox.

Traditionally, a worker (such as a fracking technician, driver of the sandbox positioning vehicle, or other laborer) must position a ladder against the side wall of the sandbox, climb its rungs, and walk atop the roof and manually open or remove the door panel so that sand may be augured out and used in a fracking operation. Unfortunately, the act of placing and climbing a ladder has on occasion resulted in injury to the ascending worker.

Therefore, an access hatch 10 according to a preferred embodiment may include a door panel 12 positioned atop the sandbox 100 that is pivotally movable between an open configuration allowing access to an interior area defined by the sandbox 100 and a closed configuration preventing access to the interior area. The door panel 12 may include a hinged shaft 14 extending longitudinally along its pivot axis so that the door panel 12 is pivotally movable between open and closed configurations via rotation of the hinged shaft 14. Further, the access hatch 10 may include a linkage 20 having 1) an access control portion 30 operatively coupled to the door panel 12 that is configured for moving said door panel 12 between said open and closed configurations when actuated and 2) an operator control portion 40 displaced from said access control portion 30 that is configured to transmit movement data from an operator to the access control portion 30, whereby the operator is able to control movements of the door panel 12 from a ground surface. The access control portion 30 includes the hinge shaft 14 and a gear train 16 interface to the chain or rope 22 described below.

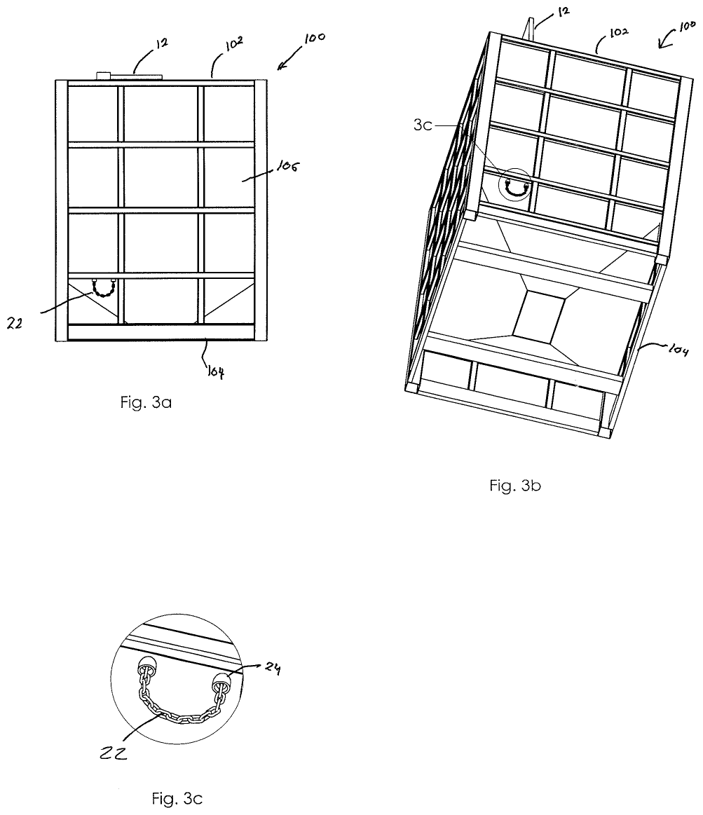

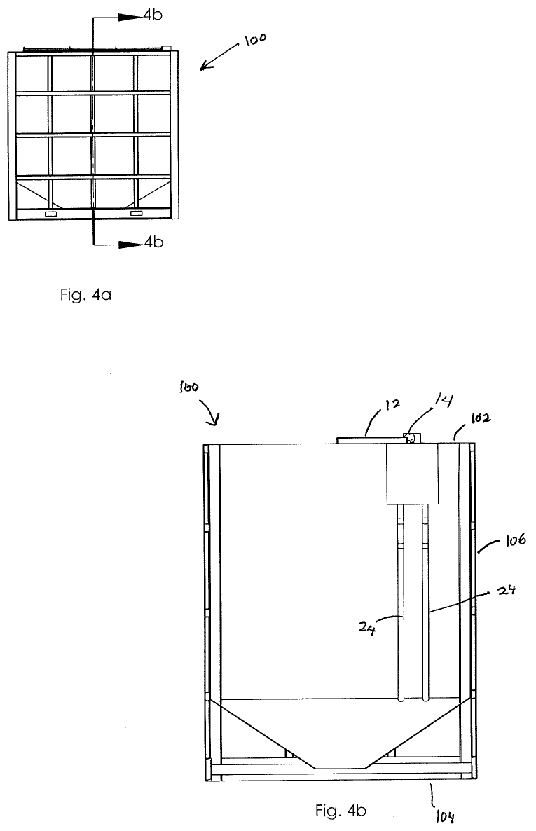

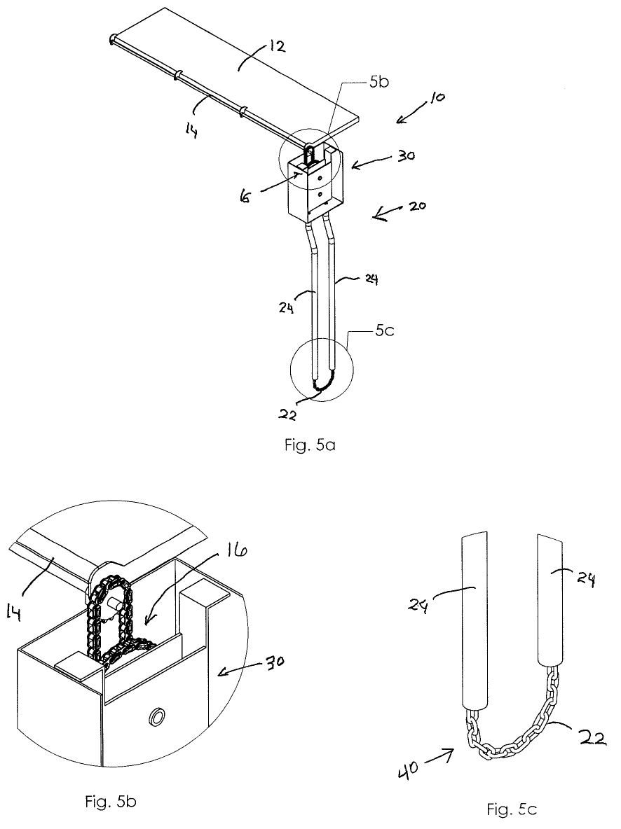

More particularly, the linkage 20 may be implemented as a sprocket and gear assembly that includes a chain or rope 22 having an elongate and circuitous configuration that is both operatively coupled to the hinge shaft 14 of the door panel 12 and positioned proximate a bottom 104 of the sandbox 100 (FIGS. 3a to 3c). The sprocket and gear assembly is configured such that a user operation of the rope 22 in one direction urges the door panel 12 toward the closed configuration and in which a user operation in another direction urges the door panel 12 toward the open configuration. The linkage 20 may include a pair of chain cover pipes 24 through which that chain 22 travels and which protect the chain from becoming clogged with sand or being subjected to other contaminants.

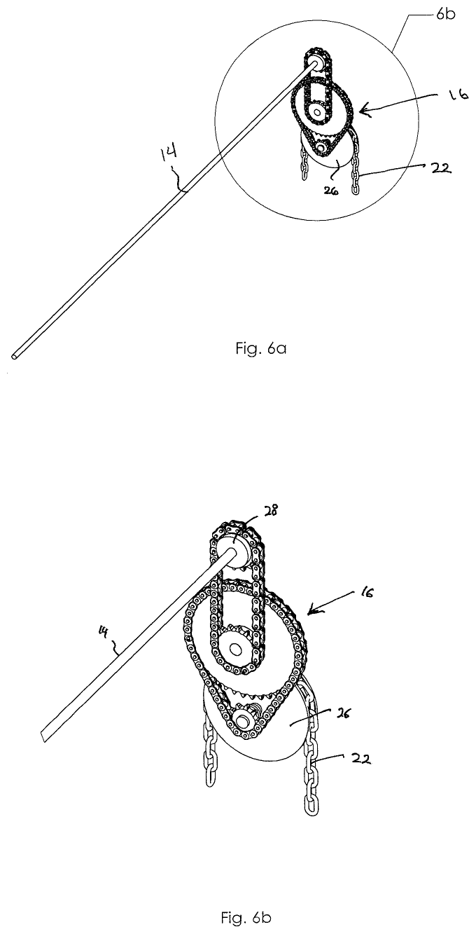

With specific reference to FIGS. 6a and 6b, the circuitous chain 22 is operable about a pulley 26 (also referred to as a pulley gear). The pulley 26 may be coupled to the gear train 16 which may include a reduction gear and a transfer gear which may be collectively coupled to a lid gear 28. It is the lid gear 28 that is coupled to or has a unitary construction with the hinge shaft 14. It is by this linkage as described above that operation of the chain 22 proximate the bottom 104 of the sandbox 100 causes a corresponding rotation of the hinge shaft 14 to thereby open or close the door panel 12, respectively.

It is understood that access to the ground-based portion of the linkage may be positioned behind a door or panel so that it is not inadvertently operated or subject to weather elements.

1. A ground operated roof-based access hatch for a sandbox that defines an interior and is configured for use in hydraulic fracturing, said access hatch comprising:
a door panel positioned atop the sandbox that is pivotally movable between an open configuration allowing access to the interior area defined by the sandbox and a closed configuration preventing access to the interior area;
a linkage having 1) an access control portion operatively coupled to said door panel that is configured for moving said door panel between said open and closed configurations when actuated and 2) an operator control portion displaced 8 from said access control portion that is configured to transmit movement data from an operator to said access control portion, whereby the operator is able to control movements of said door panel from a ground surface.

2. The access hatch as in claim 1, wherein said linkage includes a sprocket and a gear assembly that includes a chain or rope having an elongate and circuitous configuration that is operatively coupled to said door panel and positioned proximate a bottom of the sandbox, said sprocket and gear assembly having a configuration in which a user operation in one direction urges the door panel toward said closed configuration and in which a user operation in another direction urges the door panel toward said open configuration.

3. The access hatch as in claim 1, wherein said door panel includes a hinged shaft coupled to said sandbox that defines a pivot axis about which said door panel is movable between said open and closed configurations.

4. The access hatch as in claim 3, wherein said linkage 20 includes at least one chain cover pipe having a hollow configuration through which the chain is received such that the chain is protected from becoming clogged with sand.

5. The access hatch as in claim 3, wherein said gear assembly includes a pulley coupled to a gear train attached to the hinged shaft, said rope or chain extending through said pulley to operatively rotate said hinged shaft to thereby open or close the door panel, respectively, when actuated.

6. A ground-operated roof-based access hatch for a fracking sandbox, comprising:
a door panel positioned atop the sandbox;
a linkage system that includes:
an access control portion operatively coupled to the door panel and configured to move the door panel between an open configuration allowing access to an interior of the sandbox and a closed configuration preventing access to the interior of the sandbox; and
an operator control portion positioned at a bottom of the sandbox that is operatively connected to said access control portion, said operator control portion being configured to transmit movement forces to said access control portion that operates said door panel between said open and closed configurations.

7. The ground-operated access hatch as in claim 6, wherein said door panel includes a hinged shaft coupled to said sandbox that defines a pivot axis about which said door panel is movable between said open and closed configurations when said linkage system is actuated.

8. The ground-operated access hatch as in claim 6, wherein said linkage system includes a sprocket and gear assembly that includes a chain or rope having an elongate and circuitous configuration that is operatively coupled to said door panel and positioned proximate a bottom of the sandbox, said sprocket and gear assembly having a configuration in which a user operation in one direction urges the door panel toward said closed configuration and in which a user operation in another direction urges the door panel toward said open configuration.

9. The ground-operated access hatch as in claim 8, wherein said gear assembly includes a pulley coupled to a gear train attached to the hinged shaft, said rope or chain extending through said pulley to operatively rotate said hinged shaft to thereby open or close the door panel, respectively, when actuated.

10. A method of operating a ground-operated roof-based access hatch for a fracking sandbox, comprising:
pivotally mounting a door panel atop the sandbox for movement between open and closed configurations;
providing a linkage system that includes (1) an access control portion operatively coupled to said door panel and (2) an operator control portion having one end positioned at a bottom of the sandbox and a second end coupled to said access control portion; and
actuating said second end of said operator control portion to transmit movement forces to said access control portion, thereby controlling movements of said door panel from a ground surface.

11. The method as in claim 10, wherein said door panel includes a hinged shaft coupled to said sandbox that defines a pivot axis about which said door panel is movable between said open configuration allowing access to an interior of the sandbox and said closed configuration preventing access to said interior of the sandbox.

12. The method as in claim 11, further comprising:
utilizing a sprocket and gear assembly in the linkage system;
operating an elongate rope or chain coupled at one end to the sprocket and gear assembly and at another end to the access control portion so as to operate said door panel between said open and closed configurations, respectively.

13. The method as in claim 12, wherein said gear assembly includes a pulley coupled to a gear train attached to the hinged shaft, said rope or chain extending through said pulley to operatively rotate said hinged shaft to thereby open or close the door panel, respectively, when actuated.
